(19) United States
(12) Patent Application Publication
(10) Pub. No.: US 2024/0198809 A1
(43) Pub. Date: Jun. 20, 2024

(54) ELECTRIC DRIVE SYSTEM, CONTROL METHOD AND RELATED EQUIPMENT

(71) Applicant: ZF Friedrichshafen AG, Friedrichshafen (DE)

(72) Inventor: Yinghao Zhang, Shanghai (CN)

(73) Assignee: ZF Friedrichshafen AG, Friedrichshafen (DE)

(21) Appl. No.: 18/539,850

(22) Filed: Dec. 14, 2023

(30) Foreign Application Priority Data
Dec. 14, 2022 (CN) 202211608455.2

(51) Int. Cl. B60L 15/00; B60L 50/60; H02P 27/08

(52) U.S. Cl. CPC B60L 15/007; B60L 50/60; H02P 27/08; B60L 2210/12; B60L 2210/14

(57) ABSTRACT

An electric drive system includes a pair of inverters, an open winding motor, a first switch connected between upper bridges of the inverters, and a control apparatus. In a boost charging mode, the control apparatus controls the first switch to turn off, an upper bridge arm of the second inverter to turn on, and a lower bridge arm of the second inverter to turn off, and a lower bridge arm and an upper bridge arm of a corresponding phase of the first inverter to be alternately turned on in a boost charging mode, such that a charging current first flows towards a winding of a corresponding phase of the open winding motor and then flows towards a battery through the winding of the corresponding phase of the open winding motor. As such, the electric drive system can implement boost charging.

### CROSS-REFERENCE TO RELATED APPLICATION

This application claims priority to China Application No. 202211608455.2, filed on Dec. 14, 2022, the entirety of which is hereby fully incorporated by reference herein.

### TECHNICAL FIELD

The present invention relates to the field of motor control technologies, and specifically to an electric drive system, a control method, and a related device.

### BACKGROUND ART

Electric vehicles are driven by a motor to travel. With the increasing operating requirements of the electric vehicles, an open winding motor that can achieve higher power output is gradually applied to the electric vehicles.

The open winding motor means that a neutral point of a winding is opened, one inverter is connected to each of two terminals of the winding, and the two inverters jointly drive the open winding motor.

At present, a motor drive system with dual inverters can only achieve a single drive function, but cannot implement direct current charging. As a result, direct current charging can be implemented only by using an additional circuit. In addition, the direct current charging for current electric vehicles can be achieved only through a direct current charging pile whose output voltage matches a voltage of a battery. When the output voltage of the direct current charging pile is lower than the voltage of the battery, the direct current charging for the electric vehicles cannot be achieved.

It should be noted that information disclosed in the above background art section is only used to enhance the understanding of the background of the present invention, and therefore may include information that does not constitute the prior art known to those of ordinary skill in the art.

### SUMMARY OF THE INVENTION

In view of this, the present invention provides an electric drive system, a control method, and a related device. The electric drive system including a pair of inverters and an open winding motor can be used to implement boost charging, so that electric vehicles provided with the electric drive system can adapt to direct current power supply apparatuses of any specification.

According to an aspect of the present invention, there is provided an electric drive system, including a pair of inverters and an open winding motor, where the pair of inverters includes a first inverter connected to a battery and a second inverter connected to the first inverter, and two terminals of a winding of each phase of the open winding motor are respectively connected to output terminals of bridge arms of corresponding phases of the pair of inverters; the electric drive system further includes: a first switch connected between upper bridges of the pair of inverters; and a control apparatus configured to control the inverters and switches of the electric drive system, where the electric drive system is configured with a boost charging mode, and the control apparatus is configured to control the first switch to be turned off, an upper bridge arm of the second inverter to be turned on and a lower bridge arm of the second inverter to be turned off, and a lower bridge arm and an upper bridge arm of a corresponding phase of the first inverter to be alternately turned on in the boost charging mode, such that a charging current first flows towards a winding of a corresponding phase of the open winding motor and then flows towards the battery through the winding of the corresponding phase of the open winding motor.

In some embodiments, when the lower bridge arm of the corresponding phase of the first inverter is turned on, a first direct current power supply apparatus connected in parallel to a distal side of the second inverter, an upper bridge arm of a corresponding phase of the second inverter, the winding of the corresponding phase of the open winding motor, and the lower bridge arm of the corresponding phase of the first inverter form a charging and energy storage loop; and when the upper bridge arm of the corresponding phase of the first inverter is turned on, the first direct current power supply apparatus, the upper bridge arm of the corresponding phase of the second inverter, the winding of the corresponding phase of the open winding motor, the upper bridge arm of the corresponding phase of the first inverter, and the battery form a boost charging loop.

In some embodiments, the electric drive system is further configured with a standard charging mode, and the control apparatus is configured to control the first switch to be turned on in the standard charging mode, such that the charging current flows towards the battery through the first switch.

In some embodiments, the electric drive system is further configured with a boost discharging mode, and the control apparatus is configured to control the first switch to be turned off, an upper bridge arm of the first inverter to be turned on and a lower bridge arm of the first inverter to be turn off, and a lower bridge arm and an upper bridge arm of a corresponding phase of the second inverter to be alternately turned on in the boost discharging mode, such that a discharging current first flows towards a winding of a corresponding phase of the open winding motor from the battery and then flows out from the battery through the winding of the corresponding phase of the open winding motor.

In some embodiments, when the lower bridge arm of the corresponding phase of the second inverter is turned on, the battery, the upper bridge arm of the corresponding phase of the first inverter, the winding of the corresponding phase of the open winding motor, and the lower bridge arm of the corresponding phase of the second inverter form a discharging and energy storage loop; and when the upper bridge arm of the corresponding phase of the second inverter is turned on, the battery, the upper bridge arm of the corresponding phase of the first inverter, the winding of the corresponding phase of the open winding motor, the upper bridge arm of the corresponding phase of the second inverter, and a first load apparatus connected in parallel to a distal side of the second inverter form a boost discharging loop.

In some embodiments, the electric drive system is further configured with a buck discharging mode, and the control apparatus is configured to control the first switch to be turned off, the upper bridge arm of the second inverter to be turned on and the lower bridge arm of the second inverter to be turned off, and the upper bridge arm and the lower bridge arm of the corresponding phase of the first inverter to be alternately turned on in the buck discharging mode, such that a discharging current first flows out from the battery towards the winding of the corresponding phase of the open winding motor and then flows out from the winding of the corresponding phase of the open winding motor.

In some embodiments, when the upper bridge arm of the corresponding phase of the first inverter is turned on, the battery, the upper bridge arm of the corresponding phase of the first inverter, the winding of the corresponding phase of the open winding motor, the upper bridge arm of the corresponding phase of the second inverter, and a second load apparatus connected in parallel to the distal side of the second inverter form a standard discharging loop; and when the lower bridge arm of the corresponding phase of the first inverter is turned on, the winding of the corresponding phase of the open winding motor, the upper bridge arm of the corresponding phase of the second inverter, the second load apparatus, and the lower bridge arm of the corresponding phase of the first inverter form a buck discharging loop.

In some embodiments, the electric drive system further includes: a capacitor connected in parallel to the distal side of the second inverter; and a second switch connected between the capacitor and the second inverter, where the control apparatus is configured to control the second switch to be turned on in the charging mode and the discharging mode of the electric drive system.

In some embodiments, the electric drive system is further configured with a single-inverter drive mode; and the control apparatus is configured to control both the first switch and the second switch to be turned off, the second inverter to operate in an active short circuit mode, and the first inverter to drive the open winding motor alone in the single-inverter drive mode.

In some embodiments, the electric drive system is further configured with a dual-inverter drive mode; and the control apparatus is configured to control the first switch to be turned on, the second switch to be turned on or turned off, and the pair of inverters to jointly drive the open winding motor in the dual-inverter drive mode.

In some embodiments, the second switch is arranged at an end of the second inverter; or the second switch is arranged at an end of the capacitor.

In some embodiments, the second switch and/or the first switch are/is (a) power semiconductor switch(es).

According to another aspect of the present invention, there is provided a control method for controlling the electric drive system according to any one of the above embodiments, including: controlling the first switch to be turned off, the upper bridge arm of the second inverter to be turned on and the lower bridge arm of the second inverter to be turned off, and the lower bridge arm and the upper bridge arm of the corresponding phase of the first inverter to be alternately turned on through synchronous or asynchronous first PWM signals of each phase in response to connecting the first direct current power supply apparatus whose output voltage is lower than the voltage of the battery to the distal side of the second inverter, such that the electric drive system enters the boost charging mode in which the first direct current power supply apparatus first charges the winding of the corresponding phase of the open winding motor, and then charges the battery through the winding of the corresponding phase of the open winding motor.

In some embodiments, the control method further includes: controlling the first switch to be turned off, the upper bridge arm of the first inverter to be turned on and the lower bridge arm of the first inverter to be turned off, and the lower bridge arm and the upper bridge arm of the corresponding phase of the second inverter to be alternately turned on through synchronous or asynchronous second PWM signals of each phase in response to connecting the first load apparatus whose load voltage is higher than the voltage of the battery to the distal side of the second inverter, such that the electric drive system enters the boost discharging mode in which the battery first discharges to the winding of the corresponding phase of the open winding motor and then discharges to the first load apparatus through the winding of the corresponding phase of the open winding motor.

In some embodiments, the control method further includes: controlling the first switch to be turned off, the upper bridge arm of the second inverter to be turned on and the lower bridge arm of the second inverter to be turned off, and the upper bridge arm and the lower bridge arm of the corresponding phase of the first inverter to be alternately turned on through synchronous or asynchronous third PWM signals of each phase in response to connecting the second load apparatus whose load voltage is lower than the voltage of the battery to the distal side of the second inverter, such that the electric drive system enters the buck discharging mode in which the battery first discharges to the second load apparatus through the winding of the corresponding phase of the open winding motor and then the winding of the corresponding phase of the open winding motor discharges to the second load apparatus.

In some embodiments, the electric drive system further includes a capacitor connected in parallel to the distal side of the second inverter and a second switch connected between the capacitor and the second inverter, where the second switch is controlled to be turned on in the charging mode and the discharging mode of the electric drive system; the control method further includes: in response to a single-inverter drive signal, controlling both the first switch and the second switch to be turned off, the second inverter to operate in the active short circuit mode, and the first inverter to operate in the single-inverter drive mode in which the first inverter drives the open winding motor alone through a first SVPWM signal; and in response to a dual-inverter drive signal, controlling the first switch to be turned on, the second switch to be turned on or turned off, and the two inverters to operate in the dual-inverter drive mode in which the two inverters jointly drive the open winding motor through second SVPWM signals.

In some embodiments, the control method further includes: synchronously controlling, according to power requirements, bridge arms of one phase, two phases, or three phases of the inverters operating in working modes, where the working modes include the charging mode, the discharging mode, and the drive mode.

According to another aspect of the present invention, there is provided a control apparatus, configured to implement the control method according to any one of the above embodiments, including: a boost charging control module configured to control the first switch to be turned off, the upper bridge arm of the second inverter to be turned on and the lower bridge arm of the second inverter to be turned off, and the lower bridge arm and the upper bridge arm of the corresponding phase of the first inverter to be alternately turned on through synchronous or asynchronous first PWM signals of each phase in response to connecting the first direct current power supply apparatus whose output voltage is lower than the voltage of the battery to the distal side of the second inverter, such that the electric drive system enters the boost charging mode in which the first direct current power supply apparatus first charges the winding of the corresponding phase of the open winding motor, and then charges the battery through the winding of the corresponding phase of the open winding motor.

According to another aspect of the present invention, there is provided an electronic device, including: a processor; and a memory storing executable instructions, where when the executable instructions are executed by the processor, the control method according to any one of the above embodiments is implemented.

According to another aspect of the present invention, there is provided a computer-readable storage medium for storing a program, where when the program is executed by the processor, the control method according to any one of the above embodiments is implemented.

Compared with the prior art, the present invention has at least the following beneficial effects:
for the electric drive system of the present invention, the first switch is arranged between the upper bridges of the first inverter and the second inverter, when the first switch is controlled to be turned off, the upper bridge arm of the second inverter is controlled to be turned on and the lower bridge arm of the second inverter is controlled to be turned off, and the lower bridge arm and the upper bridge arm of the corresponding phase of the first inverter are controlled to be alternately turned on, the electric drive system can operate in the boost charging mode, causing the winding of the corresponding phase of the open winding motor to be charged and store energy, and then causing the battery to be boost charged through the winding of the corresponding phase of the open winding motor. Therefore, even if a low-specification direct current power supply apparatus is connected to the distal side of the second inverter, efficient, smooth, and stable charging of the battery can still be implemented, so that the electric vehicles provided with the electric drive system of the present invention can adapt to direct current power supply apparatuses of any specification.

Boost discharging and buck discharging can also be implemented by utilizing the electric drive system of the present invention, so that the electric vehicles provided with the electric drive system of the present invention can supply power to load apparatuses of any specification.

In addition, the electric drive system of the present invention can also implement single-inverter drive and dual-inverter drive, so as to flexibly adjust the drive modes according to the operating power requirements of the electric vehicles.

It should be understood that the above general description and the following detailed description are only exemplary and explanatory, and cannot limit the present invention.

### BRIEF DESCRIPTION OF THE DRAWINGS

The accompanying drawings herein, which are incorporated into and constitute a part of the description, illustrate embodiments consistent with the present invention and, together with the description, are used to explain principles of the present invention. Obviously, the accompanying drawings described below show merely some of the embodiments of the present invention, and those of ordinary skill in the art would also have obtained other accompanying drawings according to these accompanying drawings without any creative effort.

FIG. 1 is a schematic diagram of a structure of an electric drive system according to an embodiment of the present invention;

FIG. 2 is a schematic diagram of an electric drive system in a boost charging mode according to an embodiment of the present invention;

FIG. 3 is a schematic diagram of an electric drive system in a standard charging mode according to an embodiment of the present invention;

FIG. 4 is a schematic diagram of an electric drive system in a boost discharging mode according to an embodiment of the present invention;

FIG. 5 is a schematic diagram of an electric drive system in a buck discharging mode according to an embodiment of the present invention;

FIG. 6 is a schematic diagram of an electric drive system in a single-inverter drive mode according to an embodiment of the present invention;

FIG. 7 is a schematic diagram of an electric drive system in a dual-inverter drive mode according to an embodiment of the present invention;

FIG. 8 is a schematic diagram of a structure of an electric drive system according to another embodiment of the present invention;

FIG. 9 is a schematic diagram of steps of a control method according to an embodiment of the present invention;

FIG. 10 is a schematic diagram of modules of a control apparatus according to an embodiment of the present invention; and

FIG. 11 is a schematic diagram of a structure of an electronic device according to an embodiment of the present invention.

### DETAILED DESCRIPTION

Now exemplary implementations will be described more fully with reference to the accompanying drawings. However, the exemplary implementations can be implemented in many forms and should not be construed as being limited to the implementations set forth herein. On the contrary, these implementations are provided to make the present invention thorough and complete, and to fully convey the concept of the exemplary implementations to those skilled in the art.

The accompanying drawings are only schematic illustrations of the present invention, and are not necessarily drawn to scale. In the accompanying drawings, the same reference numerals denote the same or similar parts, and thus the repeated description thereof will be omitted. Some block diagrams shown in the accompanying drawings are functional entities, which do not necessarily correspond to physically or logically independent entities. These functional entities may be implemented in the form of software, in one or more hardware modules or integrated circuits, or in different networks and/or processor apparatuses and/or micro-controller apparatuses.

In addition, the process shown in the accompanying drawings is only an exemplary illustration, and does not necessarily include all steps. For example, some steps can be divided, and some steps can be combined or partially combined, and the actual execution order thereof may be changed based on actual conditions. The terms “first”, “second” and similar terms used in the specific description do not denote any order, quantity, or importance, but are merely used to distinguish different components. It should be noted that the embodiments in the present invention and features of the various embodiments can be combined with each other without conflict.

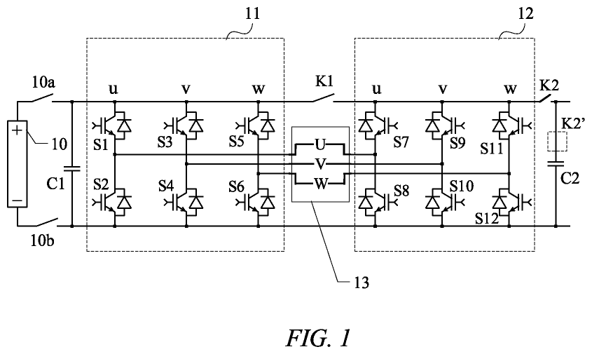

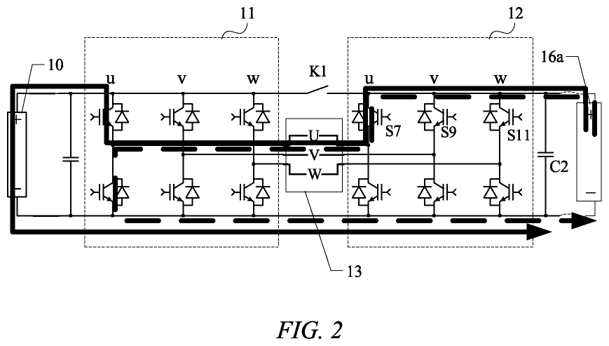

FIG. 1 shows a structure of an electric drive system according to an embodiment of the present invention, and FIG. 2 is a schematic diagram of the electric drive system in a boost charging mode. Referring to FIG. 1 and FIG. 2, the electric drive system provided in this embodiment of the present invention includes a pair of inverters and an open winding motor 13, where the pair of inverters include a first inverter 11 connected to a battery 10 and a second inverter 12 connected to the first inverter 11, and two terminals of a winding of each phase of the open winding motor 13 are respectively connected to output terminals of bridge arms of corresponding phases of the pair of inverters.

Specifically, a proximal side (a side close to the battery 10) of the first inverter 11 is connected in parallel to a positive electrode and a negative electrode of the battery 10, an upper bridge of the first inverter is connected to the positive electrode of the battery 10, and a lower bridge of the first inverter is connected to the negative electrode of the battery 10; and a proximal side of the second inverter 12 is connected in parallel to a distal side (a side away from the battery 10) of the first inverter 11, an upper bridge of the second inverter 12 is connected to the upper bridge of the first inverter 11, and a lower bridge of the second inverter 12 is connected to the lower bridge of the first inverter 11.

The positive electrode and the negative electrode of the battery 10 may be respectively provided with a positive switch 10a and a negative switch 10b to ensure circuit safety. The positive switch 10a and the negative switch 10b are both turned on in various working modes (including charging and discharging modes and drive modes) of the electric drive system, and will not be explained again in the following. In addition, the positive and negative electrodes of the battery 10 may also be connected in parallel to a first capacitor C1 for stabilizing the voltage of the battery and implementing the function of voltage filtering.

The open winding motor 13 may be a three-phase motor, including windings of a U phase, a V phase, and a W phase. Correspondingly, each of the first inverter 11 and the second inverter 12 is provided with bridge arms of a u phase, a v phase, and a w phase. Two terminals of the winding of the U phase of the open winding motor 13 are respectively connected to the output terminals of the bridge arms of the u phases of the first inverter 11 and the second inverter 12. Two terminals of the winding of the V phase of the open winding motor 13 are respectively connected to the output terminals of the bridge arms of the v phases of the first inverter 11 and the second inverter 12. Two terminals of the winding of the W phase of the open winding motor 13 are respectively connected to the output terminals of the bridge arms of the w phases of the first inverter 11 and the second inverter 12.

The bridge arm of each phase of the first inverter 11 includes two bridge arms, namely an upper bridge arm and a lower bridge arm. Each bridge arm may include one switching transistor and one anti-parallel diode, or a plurality of switching transistors and corresponding anti-parallel diodes. The mentioned switching transistors may be metal-oxide-semiconductor field-effect transistors (MOSFETs) or insulated-gate bipolar transistors (IGBTs). In FIG. 1, S1 to S6 represent the switching transistors of the first inverter 11. Similarly, the second inverter 12 includes six bridge arms. In FIG. 1, S7 to S12 represent the switching transistors of the bridge arms of the second inverter 12.

With continued reference to FIG. 1 and FIG. 2, the electric drive system further includes a first switch K1 connected between the upper bridges of the pair of inverters. Therefore, in this embodiment, the lower bridges of the first inverter 11 and the second inverter 12 are directly connected, and the upper bridges are connected through the first switch K1.

The electric drive system further includes a control apparatus (not specifically shown in the figure) configured to control the inverters and switches of the electric drive system. The control apparatus may also receive various signals, such as an operating status of a vehicle, and a charging current, a voltage, and a power of a charging apparatus, so as to control the inverters and the switches of the electric drive system to enable the electric drive system to enter different working modes.

The electric drive system is configured with a boost charging mode, and the control apparatus is configured to control the first switch K1 to be turned off, an upper bridge arm of the second inverter 12 to be turned on and a lower bridge arm of the second inverter to be turned off, and a lower bridge arm and an upper bridge arm of a corresponding phase of the first inverter 11 to be alternately turned on in the boost charging mode, such that a charging current first flows towards a winding of a corresponding phase of the open winding motor 13 and then flows towards the battery through the winding of the corresponding phase of the open winding motor 13.

Specifically, as shown in FIG. 2, in the boost charging mode, the upper bridge arms of the u phase, the v phase, and the w phase of the second inverter 12 are turned on and the lower bridge arms of the three phases are turned off, such that distal sides of the windings of the U phase, the V phase, and the W phase of the open winding motor 13 are connected together through the switching transistors S7, S9, and S11. In this case, the second inverter 12 is equivalent to forming a motor neutral point or a motor star point, while the first inverter 11 operates in the direct current boost mode. When the lower bridge arm of the corresponding phase (such as u phase) of the first inverter 11 is turned on, a first direct current power supply apparatus 16a connected in parallel to the distal side of the second inverter 12, an upper bridge arm of a corresponding phase (u phase) of the second inverter 12, the winding of the corresponding phase (U phase) of the open winding motor 13, and the lower bridge arm of the corresponding phase (u phase) of the first inverter 11 form a charging and energy storage loop as shown by the dashed arrow. In this case, the charging current is transmitted to the winding of the U phase of the open winding motor 13 from the first direct current power supply apparatus 16a, causing the winding of the U phase to be charged and store energy. When the upper bridge arm of the corresponding phase (u phase) of the first inverter 11 is turned on, the first direct current power supply apparatus 16a, the upper bridge arm of the corresponding phase (u phase) of the second inverter 12, the winding of the corresponding phase (U phase) of the open winding motor, the upper bridge arm of the corresponding phase (u phase) of the first inverter 11, and the battery 10 form a boost charging loop as shown by a solid arrow. In this case, the charging current is transmitted to the battery 10 from the first direct current power supply apparatus 16a through the winding of the U phase of the open winding motor 13. A charging voltage of the first direct current power supply apparatus 16a is superimposed with an energy storage voltage of the winding of the U phase to implement boost charging of the battery 10.

The bridge arms of the u phase, the v phase, and the w phase of the first inverter 11 operating in the direct current boost mode may be synchronously or alternately controlled through pulse width modulation (PWM) signals. Therefore, in other embodiments, the charging and energy storage loop and the boost charging loop may pass through bridge arms of the other one or more phases of the first inverter 11, and correspondingly pass through a winding of a corresponding phase of the open winding motor 13 and an upper bridge arm of a corresponding phase of the second inverter 12, without being limited to the u phase mentioned in the above examples.

In the boost charging mode of the electric drive system, charging and energy storage of the winding of the corresponding phase of the open winding motor 13 is first implemented, and then boost charging of the battery 10 is implemented through the winding of the corresponding phase of the open winding motor 13. Therefore, even if an output voltage of the first direct current power supply apparatus 16a is lower than a voltage specification of the battery 10, efficient, smooth, and stable charging of the battery 10 can still be achieved through boost charging.

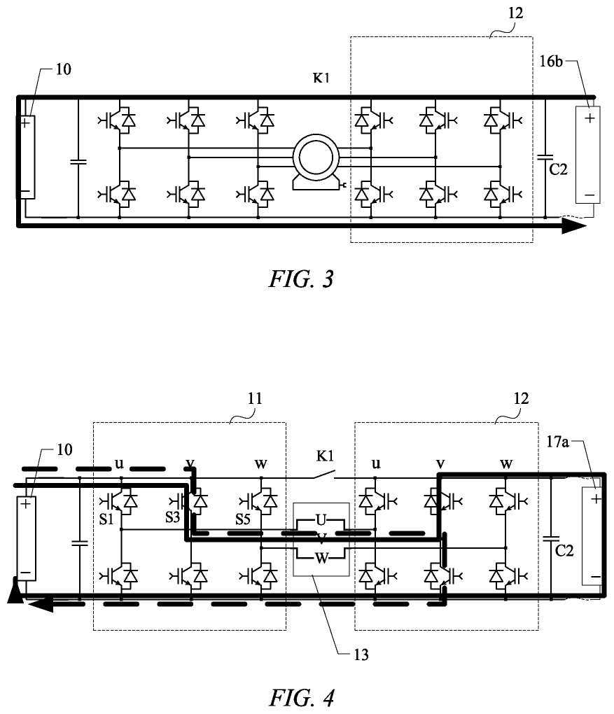

FIG. 3 is a schematic diagram of an electric drive system in a standard charging mode according to an embodiment of the present invention. With reference to FIG. 1 and FIG. 3, the electric drive system is further configured with the standard charging mode, and the control apparatus is configured to control the first switch K1 to be turned on in the standard charging mode, such that the charging current flows towards the battery 10 through the first switch K1.

In the standard charging mode, a second direct current power supply apparatus 16b connected in parallel to the distal side of the second inverter 12 has an output voltage that matches the voltage specification of the battery 10. In this case, referring to the solid arrow in FIG. 3, the charging current may directly flow towards the battery 10 through the first switch K1.

Each of positive and negative electrodes of each of the first direct current power supply apparatus 16a and the second direct current power supply apparatus 16b is connected to a corresponding switch (not specifically shown in the figure), so that the circuit can be turned on when the corresponding direct current power supply apparatus is connected accurately, thereby ensuring circuit safety.

In addition, when the distal side of the second inverter 12 is connected to a high-specification direct current power supply apparatus, the high-specification direct current power supply apparatus can adaptively adjust an output voltage thereof according to the voltage specification of the battery 10 to implement direct current charging of the battery 10.

Therefore, electric vehicles provided with the electric drive system can adapt to direct current power supply apparatuses of any specification.

FIG. 4 is a schematic diagram of an electric drive system in a boost discharging mode according to an embodiment of the present invention. With reference to FIG. 1 and FIG. 4, the electric drive system is further configured with the boost discharging mode, and the control apparatus is configured to control the first switch K1 to be turned off, an upper bridge arm of the first inverter 11 to be turned on and a lower bridge arm of the first inverter to be turned off, and a lower bridge arm and an upper bridge arm of a corresponding phase of the second inverter 12 to be alternately turned on in the boost discharging mode, such that a discharging current first flows towards a winding of a corresponding phase of the open winding motor 13 from the battery 10, and then flows out from the battery 10 through the winding of the corresponding phase of the open winding motor 13.

Specifically, as shown in FIG. 4, in the boost discharging mode, the upper bridge arms of the u phase, the v phase, and the w phase of the first inverter 11 are turned on and the lower bridge arms of the three phases are turned off, such that the proximal sides of the windings of the U phase, the V phase, and the W phase of the open winding motor 13 are connected together through the switching transistors S1, S3, and S5. In this case, the first inverter 11 is equivalent to forming the motor neutral point or motor star point, while the second inverter 12 operates in the direct current boost mode. When the lower bridge arm of the corresponding phase (such as v phase) of the second inverter 12 is turned on, the battery 10, the upper bridge arm of the corresponding phase (v phase) of the first inverter 11, the winding of the corresponding phase (V phase) of the open winding motor 13, and the lower bridge arm of the corresponding phase (v phase) of the second inverter 12 form a discharging and energy storage loop as shown by the dashed arrow. In this case, the discharging current is transmitted to the winding of the V phase of the open winding motor 13 from the battery 10, causing the winding of the V phase to store energy. When the upper bridge arm of the corresponding phase (v phase) of the second inverter 12 is turned on, the battery 10, the upper bridge arm of the corresponding phase (v phase) of the first inverter 11, the winding of the corresponding phase (V phase) of the open winding motor 13, the upper bridge arm of the corresponding phase (v phase) of the second inverter 12, and a first load apparatus 17a connected in parallel to a distal side of the second inverter 12 form a boost discharging loop as shown by the solid arrow. In this case, the discharging current is transmitted to the first load apparatus 17a from the battery 10 through the winding of the V phase of the open winding motor 13, and a discharging voltage of the battery 10 is superimposed with an energy storage voltage of the winding of the V phase to implement boost discharging to the first load apparatus 17a.

The bridge arms of the u phase, the v phase, and the w phase of the second inverter 12 operating in the direct current boost mode may be synchronously or alternately controlled through pulse width modulation (PWM) signals. Therefore, in other embodiments, the discharging and energy storage loop and the boost discharging loop may pass through bridge arms of the other one or more phases of the second inverter 12, and correspondingly pass through a winding of a corresponding phase of the open winding motor 13 and an upper bridge arm of a corresponding phase of the first inverter 11, without being limited to the v phase mentioned in the above examples.

In this embodiment, the first load apparatus 17a is a load with a voltage specification higher than the battery voltage of the battery 10, a vehicle to be rescued, etc. In the boost discharging mode of the electric drive system, discharging to and energy storage of the winding of the corresponding phase of the open winding motor 13 can be first implemented, and then boost discharging to the first load apparatus 17a is implemented through the winding of the corresponding phase of the open winding motor 13, so that discharging rescue of the high-specification first load apparatus 17a is implemented under emergency conditions.

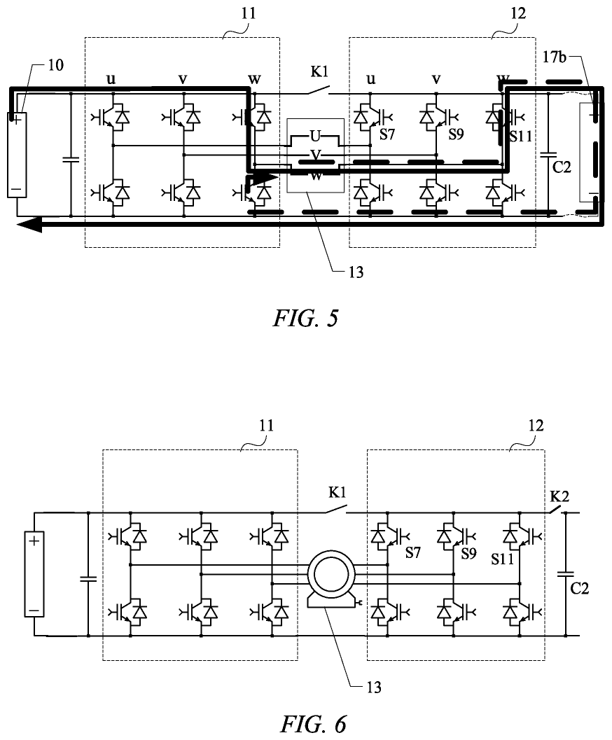

FIG. 5 is a schematic diagram of an electric drive system in a buck discharging mode according to an embodiment of the present invention. With reference to FIG. 1 and FIG. 5, the electric drive system is further configured with a buck discharging mode, and the control apparatus is configured to control the first switch K1 to be turned off, the upper bridge arm of the second inverter 12 to be turned on and the lower bridge arm of the second inverter to be turned off, and the upper bridge arm and the lower bridge arm of the corresponding phase of the first inverter 11 to be alternately turned on in the buck discharging mode, such that a discharging current first flows out from the battery 10 towards the winding of the corresponding phase of the open winding motor 13 and then flows out from the winding of the corresponding phase of the open winding motor 13.

Specifically, as shown in FIG. 5, in the buck discharging mode, the upper bridge arms of the bridge arms of the u phase, the v phase, and the w phase of the second inverter 12 are turned on and the lower bridge arms of the bridge arms of the three phases are turned off, such that the distal sides of the windings of the U phase, the V phase, and the W phase of the open winding motor 13 are connected together through the switching transistors S7, S9, and S11. In this case, the second inverter 12 is equivalent to forming a motor neutral point or a motor star point, while the first inverter 11 operates in the direct current buck mode. When the upper bridge arm of the corresponding phase (such as w phase) of the first inverter 11 is turned on, the battery 10, the upper bridge arm of the corresponding phase (w phase) of the first inverter 11, the winding of the corresponding phase (W phase) of the open winding motor 13, the upper bridge arm of the corresponding phase (w phase) of the second inverter 12, and the second load apparatus 17b connected in parallel to the distal side of the second inverter 12 form a standard discharging loop as shown by the solid arrow. In this case, the discharging current is transmitted to the second load apparatus 17b from the battery 10 through the winding of the W phase of the open winding motor 13, and in this process, the winding of the W phase stores part of energy. When the lower bridge arm of the corresponding phase (w phase) of the first inverter 11 is turned on, the winding of the corresponding phase (W phase) of the open winding motor 13, the upper bridge arm of the corresponding phase (w phase) of the second inverter 12, the second load apparatus 17b, and the lower bridge arm of the corresponding phase (w phase) of the first inverter 11 form a buck discharging loop as shown by the dashed arrow. In this case, the discharging current is transmitted to the second load apparatus 17b from the winding of the W phase of the open winding motor 13, and the discharging current from the winding of the W phase is small, so that buck discharging to the second load apparatus 17b is implemented.

The bridge arms of the u phase, the v phase, and the w phase of the first inverter 11 operating in the direct current buck mode may be synchronously or alternately controlled through pulse width modulation (PWM) signals. Therefore, in other embodiments, the standard discharging loop and the buck discharging loop may pass through bridge arms of the other one or more phases of the first inverter 11, and correspondingly pass through a winding of a corresponding phase of the open winding motor 13 and an upper bridge arm of a corresponding phase of the second inverter 12, without being limited to the w phase mentioned in the above examples.

In this embodiment, the voltage specification of the second load apparatus 17b is lower than the battery voltage of the battery 10. In the buck discharging mode of the electric drive system, the discharging current adapts to the voltage specification of the second load apparatus 17b, thereby implementing stable discharging to the low-specification second load apparatus 17b.

Each of positive and negative electrodes of each of the first load apparatus 17a and the second load apparatus 17b is connected to a corresponding switch (not specifically shown in the figure), so that the circuit can be turned on when the corresponding load apparatus is connected accurately, thereby ensuring circuit safety.

In the above embodiments, with reference to FIG. 1 to FIG. 5, the electric drive system further includes a capacitor C2 (hereinafter referred to as a second capacitor C2) connected in parallel to the distal side of the second inverter 12; and a second switch K2 connected between the second capacitor C2 and the second inverter 12; and the control apparatus is configured to control the second switch K2 to be turned on in the charging mode and the discharging mode of the electric drive system, so that a filtering effect is achieved by stabilizing the charging voltage/discharging voltage through the second capacitor C2.

In the boost charging mode as shown in FIG. 2, the standard charging mode as shown in FIG. 3, the boost discharging mode as shown in FIG. 4, and the buck discharging mode as shown in FIG. 5, the second switch (not specifically shown) connected between the second capacitor C2 and the second inverter 12 is turned on so as to turn on the charging circuit/discharging circuit, and cause the second capacitor C2 to be connected to the charging circuit/discharging circuit.

FIG. 6 is a schematic diagram of an electric drive system in a single-inverter drive mode according to an embodiment of the present invention. With reference to FIG. 1 and FIG. 6, the electric drive system is further configured with a single-inverter drive mode. The control apparatus is configured to control both the first switch K1 and the second switch K2 to be turned off, the second inverter 12 to operate in an active short circuit mode, and the first inverter 11 to drive the open winding motor 13 alone in the single-inverter drive mode.

In the active short circuit (ASC) mode, the upper bridge of the second inverter 12 is fully turned on, or the lower bridge of the second inverter is fully turned on. In this embodiment, it is preferred to make the upper bridge of the second inverter 12 fully turned on, and even if the switching transistors S7, S9, and S11 are turned on, the second inverter 12 operates in the active short circuit mode of the upper bridge arm. In addition, the second switch K2 is turned off, such that the second capacitor C2 is disconnected from the second inverter 12.

The single-inverter drive mode is an economic mode. In the single-inverter drive mode, the first inverter 11 can drive the open winding motor 13 alone under the control of a space vector pulse-width modulation (SVPWM) signal, and in this case, the electric drive system operates in a low power mode and has higher efficiency. According to the output power requirements of the open winding motor 13, the first inverter 11 can be controlled through the SVPWM signal to drive the open winding motor 13.

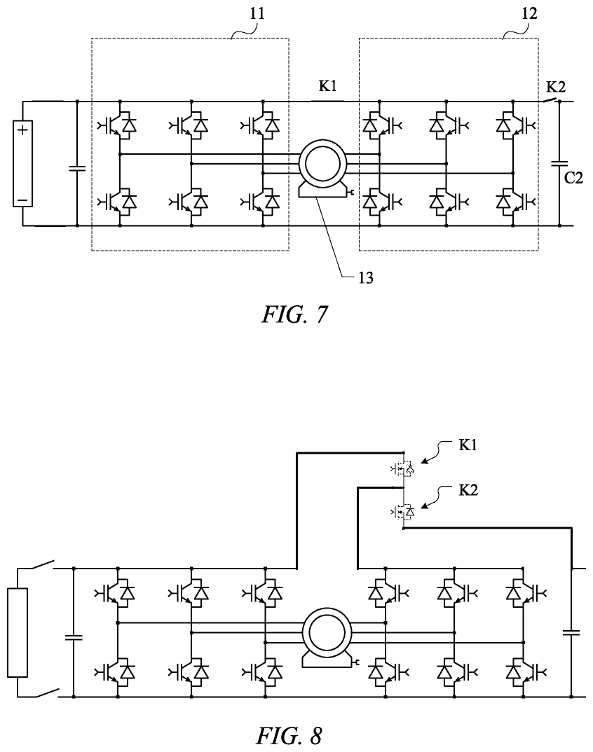

FIG. 7 is a schematic diagram of an electric drive system in a dual-inverter drive mode according to an embodiment of the present invention. With reference to FIG. 1 and FIG. 7, the electric drive system is further configured with a dual-inverter drive mode. The control apparatus is configured to control the first switch K1 to be turned on, the second switch K2 to be turned on or turned off, and the two inverters to jointly drive the open winding motor 13 in the dual-inverter drive mode.

The second switch K2 is turned on, such that the second capacitor C2 can be connected to the electric drive system to achieve better filtering effects. Therefore, in this embodiment, the second switch K2 can be turned on in the dual-inverter drive mode.

In the dual-inverter drive mode, six bridge arms of the first inverter 11 and the second inverter 12 operate jointly, which may meet the continuous high-power operating requirements of the open winding motor 13. The first inverter 11 and the second inverter 12 can jointly drive the open winding motor 13 under the control of the SVPWM signal.

In some embodiments, as shown in FIG. 1, the second switch K2 may be arranged at an end of the second inverter 12; or the second switch can be arranged at an end of the second capacitor C2, as shown by the dashed box K2′ in FIG. 1.

In some embodiments, the second switch K2 and/or the first switch K1 may be a power semiconductor switch(es). FIG. 8 shows a structure of an electric drive system according to another embodiment of the present invention. With reference to FIG. 1 and FIG. 8, the first switch K1/the second switch K2 may be a common electronic switch as shown in FIG. 1, and the first switch K1/the second switch K2 may alternatively be the power semiconductor switch as shown in FIG. 8. The power semiconductor switch has a smaller size and lower power loss, which can improve the performance of the electric drive system.

The electric drive system of the above embodiments can implement various charging and discharging modes, such as the boost charging mode, the standard charging mode, the boost discharging mode, and the buck discharging mode, by turning on/off of the first switch K1 and the second switch K2 in combination with the turning on/off of the bridge arms of each phase of the first inverter 11 and the second inverter 12, so that the electric vehicles provided with the electric drive system can adapt to the direct current power supply apparatuses of any specification and supply power to the load apparatuses of any specification. In addition, the electric drive system can also implement the single-inverter drive mode and the dual-inverter drive mode, so as to flexibly adjust the drive modes according to the operating power requirements of the electric vehicles.

An embodiment of the present invention further provides a control method for controlling the electric drive system as described in any of the above embodiments. Features and principles of the electric drive system as described in any of the above embodiments are both applicable to the following embodiments of the control method. In the following embodiments of the control method, the features and principles of the electric drive system that have been described will not be repeated again.

The control method of this embodiment of the present invention may be performed by the control apparatus for the electric vehicles. The mentioned control apparatus may be any one or more of the following electronic devices of the electric vehicles, or deployed in any one or more of the following electronic devices of the electric vehicles: a controller, a vehicle control unit (VCU), a VCU combined with a motor control unit (MCU), a VCU combined with an MCU and a battery management system (BMS).

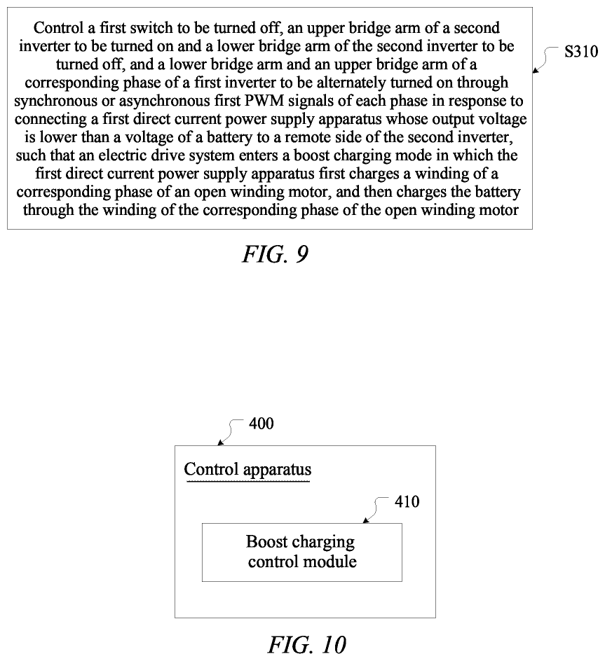

FIG. 9 shows main steps of a control method according to an embodiment of the present invention. Referring to FIG. 9 in combination with FIG. 1 and FIG. 2, the control method includes:
S310: controlling the first switch K1 to be turned off (and the second switch K2 to be turned on), the upper bridge arm of the second inverter 12 to be turned on and the lower bridge arm of the second inverter to be turned off, and the lower bridge arm and the upper bridge arm of the corresponding phase of the first inverter 11 to be alternately turned on through synchronous or asynchronous first PWM signals of each phase in response to connecting the first direct current power supply apparatus 16a whose output voltage is lower than a voltage of the battery to the distal side of the second inverter 12, such that the electric drive system enters the boost charging mode in which the first direct current power supply apparatus 16a first charges the winding of the corresponding phase of the open winding motor 13, and then charges the battery 10 through the winding of the corresponding phase of the open winding motor 13.

The electric drive system is controlled to enter the boost charging mode, so that charging and energy storage of the winding of the corresponding phase of the open winding motor 13 is first implemented, and then boost charging of the battery 10 is implemented through the winding of the corresponding phase of the open winding motor 13. Therefore, even if an output voltage of the first direct current power supply apparatus 16a is lower than a voltage specification of the battery 10, efficient, smooth, and stable charging of the battery 10 can still be achieved through boost charging.

In some embodiments, with reference to FIG. 1 and FIG. 3, the control method further includes: controlling the first switch K1 to be turned on (and the second switch K2 to be turned on) in response to connecting the second direct current power supply apparatus 16b whose output voltage matches with the voltage of the battery to the distal side of the second inverter 12, such that the electric drive system enters the standard charging mode in which the second direct current power supply apparatus 16b directly charges the battery 10.

In some embodiments, with reference to FIG. 1 and FIG. 4, the control method further includes: controlling the first switch K1 to be turned off (and the second switch K2 to be turned on), the upper bridge arm of the first inverter 11 to be turned on and the lower bridge arm of the first inverter to be turned off, and the lower bridge arm and the upper bridge arm of the corresponding phase of the second inverter 12 to be alternately turned on through synchronous or asynchronous second PWM signals of each phase in response to connecting the first load apparatus 17a whose load voltage is higher than the voltage of the battery to the distal side of the second inverter 12, such that the electric drive system enters the boost discharging mode in which the battery 10 first discharges to the winding of the corresponding phase of the open winding motor 13 and then discharges to the first load apparatus 17a through the winding of the corresponding phase of the open winding motor 13.

The electric drive system is controlled to enter the boost discharging mode, so that discharging to and energy storage of the winding of the corresponding phase of the open winding motor 13 is first implemented, and then boost discharging to the first load apparatus 17a is implemented through the winding of the corresponding phase of the open winding motor 13, so that discharging rescue of the high-specification first load apparatus 17a is implemented under emergency conditions.

In some embodiments, with reference to FIG. 1 and FIG. 5, the control method further includes: controlling the first switch K1 to be turned off (the second switch K2 to be turned on), the upper bridge arm of the second inverter 12 to be turned on and the lower bridge arm of the second inverter to be turned off, and the upper bridge arm and the lower bridge arm of the corresponding phase of the first inverter 11 to be alternately turned on through synchronous or asynchronous third PWM signals of each phase in response to connecting the second load apparatus 17b whose load voltage is lower than the voltage of the battery to the distal side of the second inverter 12, such that the electric drive system enters the buck discharging mode in which the battery 10 first discharges to the second load apparatus 17b through the winding of the corresponding phase of the open winding motor 13 and the winding of the corresponding phase of the open winding motor 13 discharges to the second load apparatus 17b.

The electric drive system is controlled to enter the buck discharging mode, such that the discharging current adapts to the voltage specification of the second load apparatus 17b, thereby implementing stable discharging to the low-specification second load apparatus 17b.

In some embodiments, with reference to FIG. 1 and FIG. 6, the control method further includes: in response to a single-inverter drive signal, controlling both the first switch K1 and the second switch K2 to be turned off, the second inverter 12 to operate in the active short circuit mode, and the first inverter 11 to operate in the single-inverter drive mode in which the first inverter drives the open winding motor 13 alone through a first SVPWM signal.

The electric drive system is controlled to enter the single-inverter drive mode, such that an output power of the open winding motor 13 adapts to the output power requirements of the electric drive system and has higher operating efficiency.

In some embodiments, with reference to FIG. 1 and FIG. 7, the control method further includes: in response to a dual-inverter drive signal, controlling the first switch K1 to be turned on, the second switch K2 to be turned on or turned off, and the two inverters to operate in the dual-inverter drive mode in which the two inverters jointly drive the open winding motor 13 through a second SVPWM signal.

The electric drive system is controlled to enter the dual-inverter drive mode, such that six bridge arms of the first inverter 11 and the second inverter 12 operate jointly, so as to meet the high-power operating requirements of the open winding motor 13.

Further, the control method according to the above embodiments further includes: synchronously controlling, according to power requirements, bridge arms of one phase, two phases, or three phases of the inverters operating in working modes, where the working modes include the charging mode, the discharging mode, and the drive mode.

Specifically, the lower bridge arms and the upper bridge arms of bridge arms of one phase, two phases, or three phases of the first inverter operating in the boost charging mode can be synchronously controlled to be alternately turned on in the boost charging mode through the first PWM signal according to the charging power requirements. The lower bridge arms and the upper bridge arms of bridge arms of one phase, two phases, or three phases of the second inverter operating in the boost discharging mode can be synchronously controlled to be alternately turned on in the boost discharging mode through the second PWM signal according to first discharging power requirements. The upper bridge arms and the lower bridge arms of bridge arms of one phase, two phases, or three phases of the first inverter operating in the buck discharging mode can be synchronously controlled to be alternately turned on in the buck discharging mode through the third PWM signal according to second discharging power requirements. The bridge arms of one phase, two phases, or three phases of the first inverter operating in the single-inverter drive mode can be synchronously controlled in the single-inverter drive mode through the first SVPWM signal according to first drive power requirements. The bridge arms of one phase, two phases, or three phases of the two inverters operating in the dual-inverter drive mode can be synchronously controlled in the dual-inverter drive mode through the second SVPWM signal according to second drive power requirements.

An embodiment of the present invention further provides a control apparatus for controlling the control method as described in any of the above embodiments. Features and principles of the control method based on the electric drive system according to any one of the above embodiments are both applicable to the following embodiments of the control apparatus. In the following embodiments of the control apparatus, the features and principles of the electric drive system and the control method that have been described will not be repeated again.

The control apparatus of this embodiment of the present invention may be deployed in VCUs, or distributed in VCUs and MCUs, or distributed in VCUs, MCUs, and BMS, or deployed in the controller of the electric drive system.

FIG. 10 shows main modules of a control apparatus according to an embodiment of the present invention. Referring to FIG. 10 in combination with FIG. 1, FIG. 2, and FIG. 9, the control apparatus 400 includes:
a boost charging control module 410 configured to control the first switch K1 to be turned off (and the second switch K2 to be turned on), the upper bridge arm of the second inverter 12 to be turned on and the lower bridge arm of the second inverter to be turned off, and the lower bridge arm and the upper bridge arm of the corresponding phase of the first inverter 11 to be alternately turned on through synchronous or asynchronous first PWM signals of each phase in response to connecting the first direct current power supply apparatus 16a whose output voltage is lower than the voltage of the battery to the distal side of the second inverter 12, such that the electric drive system enters the boost charging mode in which the first direct current power supply apparatus 16a first charges the winding of the corresponding phase of the open winding motor 13, and then charges the battery 10 through the winding of the corresponding phase of the open winding motor 13.

Further, the control apparatus 400 may further include modules for implementing other process steps of the embodiments of the control method, such as a boost discharging module for controlling the electric drive system to enter the boost discharging mode, a buck discharging module for controlling the electric drive system to enter the buck discharging mode, a single-inverter drive module for controlling the electric drive system to enter the single-inverter drive mode, a dual-inverter drive module for controlling the electric drive system to enter the dual-inverter drive mode, etc. For specific principles of the modules, reference may be made to the description of the embodiments of the control method mentioned above, and will not be repeated again.

The control apparatus 400 can control the electric drive system to enter various charging and discharging modes such as the boost charging mode, the standard charging mode, the boost discharging mode, and the buck discharging mode by controlling turning on/off of the first switch K1 and the second switch K2, as well as turning on/off of the bridge arms of each phase of the first inverter 11 and the second inverter 12, such that the electric vehicles provided with the control apparatus 400 can adapt to the direct current power supply apparatuses of any specification and supply power to the load apparatuses of any specification. In addition, the control apparatus 400 can also control the electric drive system to enter the single-inverter drive mode and the dual-inverter drive mode, so as to flexibly adjust the drive mode according to operating power requirements of the electric vehicles.

An embodiment of the present invention further provides an electronic device, including a processor; and a memory storing executable instructions, where when the executable instructions are executed by the processor, the control method according to any one of the above embodiments is implemented.

The electronic device of this embodiment of the present invention may be deployed in VCUs, or distributed in VCUs and MCUs, or distributed in VCUs, MCUs, and BMS, or deployed in a controller of the electric drive system.

The electronic device, by implementing the control method, can control the electric drive system to enter various charging and discharging modes such as the boost charging mode, the standard charging mode, the boost discharging mode, and buck discharging mode, such that the electric vehicles provided with the electronic device can adapt to the direct current power supply apparatuses of any specification and can supply power to the load apparatuses of any specification. In addition, the electronic device can also control the electric drive system to enter the single-inverter drive mode and the dual-inverter drive mode, so as to flexibly adjust the drive modes according to the operating power requirements of the electric vehicles.

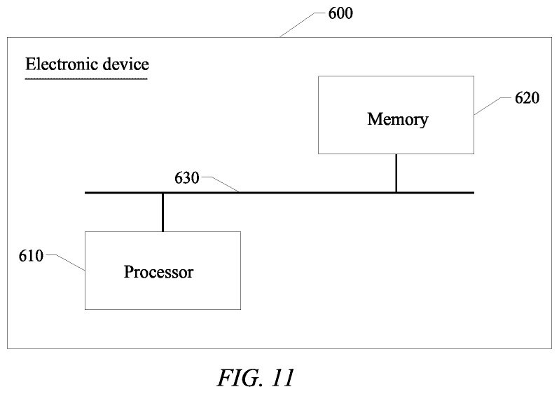

FIG. 11 shows a structure of an electronic device according to an embodiment of the present invention. As shown in FIG. 11, an electronic device 600 is embodied in the form of a general-purpose computing device. The components of the electronic device 600 may include, but are not limited to: at least one processor 610, at least one memory 620, a bus 630 for connecting different components (including the memory 620 and the processor 610), etc.

The memory 620 stores program codes, and the program codes may be executed by the processor 610, such that the processor 610 performs the steps of the control method according to any one of the above embodiments. For example, the processor 610 may perform the steps as shown in FIG. 9.

The memory 620 may include a readable medium in the form of a volatile memory unit, such as a random access memory (RAM) and/or a cache storage unit, and may further include a read-only memory (ROM).

The memory 620 may further include a program/utility tool having one or more program modules, the mentioned program modules including but not limited to: an operating system, one or more application programs, and other program modules and program data, where each of or a certain combination of these examples may include the implementation of a network environment.

The bus 630 may represent one or more of several types of bus structures, including a storage unit bus or storage unit controller, a peripheral bus, a graphics acceleration port, a processing unit, or a local area bus using any of a variety of bus structures.

The electronic device 600 may also communicate with one or more external devices, and the external devices may be one or more of devices such as a keyboard, a pointing device, and a Bluetooth device. These external devices enable a user to interact and communicate with the electronic device 600. The electronic device 600 can also communicate with one or more other computing devices, and the computer devices include a router and a modem. The communication may be performed via an input/output (I/O) interface of the electronic device 600. In addition, the electronic device 600 may also communicate with one or more networks (e.g., a local area network (LAN), a wide area network (WAN), and/or a public network, such as the Internet) via a network adapter. The network adapter may communicate with other modules of the electronic device 600 through the bus 630.

An embodiment of the present invention further provides a computer-readable storage medium for storing a program, where when the program is executed, the control method according to any one of the above embodiments is implemented. In some possible implementations, various aspects of the present invention may also be implemented in the form of a program product including program codes, where when the program product is run on a terminal device, the program codes are used to enable the terminal device to perform the control method according to any one of the above embodiments.

The storage medium in this embodiment of the present invention may be executed by processors deployed in VCUs, or distributed in VCUs and MCUs, or distributed in VCUs, MCUs, and BMS, or deployed in a controller of the electric drive system. When being executed, the storage medium can control the electric drive system to enter various charging and discharging modes such as the boost charging mode, the standard charging mode, the boost discharging mode, and the buck discharging mode, such that electric vehicles can adapt to the direct current power supply apparatuses of any specification and can supply power to the load apparatuses of any specification. In addition, the electric drive system can also be controlled to enter the single-inverter drive mode and the dual-inverter drive mode, so as to flexibly adjust the drive modes according to operating power requirements of the electric vehicles.

The storage medium may be a portable compact disc read-only memory (CD-ROM) and include program codes, and may run on terminal devices, such as personal computers. However, the storage medium of the present invention is not limited thereto, and may be any tangible medium containing or storing a program which may be used by or in combination with an instruction execution system, apparatus, or device.

The storage medium may be a readable medium or any combination of more readable media. The readable medium may be a readable signal medium or a readable storage medium. An example of the readable storage medium may be, but is not limited to electric, magnetic, optical, electromagnetic, infrared, or semiconductor systems, apparatuses or devices, or any combination of the above. A more specific example of the readable storage medium includes, but is not limited to: an electrical connection having one or more wires, a portable disk, a hard disk, a random access memory (RAM), a read only memory (ROM), an erasable programmable read only memory (EPROM or flash), fiber optics, a portable compact disk read only memory (CD-ROM), an optical storage device, a magnetic storage device, or any suitable combination thereof.

The readable signal medium may include data signals in a baseband or propagated as parts of carriers, in which readable program codes are carried. The propagated data signal may be in various forms, including but not limited to an electromagnetic signal, an optical signal, or any suitable combination thereof. The readable signal medium may also be any readable medium beyond the readable storage media. The readable medium is capable of sending, propagating or transmitting a program used by or in combination with an instruction execution system, apparatus or device or a combination. The program codes contained in the readable signal medium may be transmitted by any appropriate medium, including but not limited to wireless, wired, optical cable, RF, etc., or any appropriate combination of the above.

A program code for executing operations of the present invention may be compiled using one or more programming languages. The programming languages include object-oriented programming languages, such as Java and C++, and also include conventional procedural programming languages, such as “C” language or similar programming languages. The program code may be completely executed on a computing device of a user, partially executed on a user device, executed as a separate software package, partially executed on a computing device of a user and partially executed on a remote computing device, or completely executed on a remote computing device or server. In the circumstance involving a remote computing device, the remote computing device may be connected to a user's computing device over any type of network, including a local area network (LAN) or wide area network (WAN), or may be connected to an external computing device (for example, connected over the Internet using an Internet service provider).

The above is a further detailed description of the present invention with reference to the specific preferred implementations, and it cannot be considered that the specific implementation of the present invention is limited to these descriptions. For those of ordinary skill in the art of the present invention, several simple deductions or substitutions can be further made without departing from the concept of the present invention, and should be regarded as falling within the scope of protection of the present invention.

What is claimed is:

1. An electric drive system, comprising a pair of inverters and an open winding motor, wherein the pair of inverters comprises a first inverter connected to a battery and a second inverter connected to the first inverter, and two terminals of a winding of each phase of the open winding motor are respectively connected to output terminals of bridge arms of corresponding phases of the pair of inverters, wherein
the electric drive system further comprises:
a first switch connected between upper bridges of the pair of inverters; and
a control apparatus configured to control the inverters and switches of the electric drive system; and
the electric drive system is configured with a boost charging mode, and the control apparatus is configured to control the first switch to be turned off, an upper bridge arm of the second inverter to be turned on and a lower bridge arm of the second inverter to be turned off, and a lower bridge arm and an upper bridge arm of a corresponding phase of the first inverter to be alternately turned on in the boost charging mode, such that a charging current first flows towards a winding of a corresponding phase of the open winding motor and then flows towards the battery through the winding of the corresponding phase of the open winding motor.

2. The electric drive system according to claim 1, wherein when the lower bridge arm of the corresponding phase of the first inverter is turned on, a first direct current power supply apparatus connected in parallel to a distal side of the second inverter, an upper bridge arm of a corresponding phase of the second inverter, the winding of the corresponding phase of the open winding motor, and the lower bridge arm of the corresponding phase of the first inverter form a charging and energy storage loop; and
when the upper bridge arm of the corresponding phase of the first inverter is turned on, the first direct current power supply apparatus, the upper bridge arm of the corresponding phase of the second inverter, the winding of the corresponding phase of the open winding motor, the upper bridge arm of the corresponding phase of the first inverter, and the battery form a boost charging loop.

3. The electric drive system according to claim 1, wherein the electric drive system is further configured with a standard charging mode, and the control apparatus is configured to control the first switch to be turned on in the standard charging mode, such that the charging current flows towards the battery through the first switch.

4. The electric drive system according to claim 1, wherein the electric drive system is further configured with a boost discharging mode, and the control apparatus is configured to control the first switch to be turned off, an upper bridge arm of the first inverter to be turned on and a lower bridge arm of the first inverter to be turn off, and a lower bridge arm and an upper bridge arm of a corresponding phase of the second inverter to be alternately turned on in the boost discharging mode, such that a discharging current first flows towards a winding of a corresponding phase of the open winding motor from the battery and then flows out from the battery through the winding of the corresponding phase of the open winding motor.

5. The electric drive system according to claim 4, wherein when the lower bridge arm of the corresponding phase of the second inverter is turned on, the battery, the upper bridge arm of the corresponding phase of the first inverter, the winding of the corresponding phase of the open winding motor, and the lower bridge arm of the corresponding phase of the second inverter form a discharging and energy storage loop and
when the upper bridge arm of the corresponding phase of the second inverter is turned on, the battery, the upper bridge arm of the corresponding phase of the first inverter, the winding of the corresponding phase of the open winding motor, the upper bridge arm of the corresponding phase of the second inverter, and a first load apparatus connected in parallel to a distal side of the second inverter form a boost discharging loop.

6. The electric drive system according to claim 1, wherein the electric drive system is further configured with a buck discharging mode, and the control apparatus is configured to control the first switch to be turned off, the upper bridge arm of the second inverter to be turned on and the lower bridge arm of the second inverter to be turned off, and the upper bridge arm and the lower bridge arm of the corresponding phase of the first inverter to be alternately turned on in the buck discharging mode, such that a discharging current first flows out from the battery towards the winding of the corresponding phase of the open winding motor and then flows out from the winding of the corresponding phase of the open winding motor.

7. The electric drive system according to claim 6, wherein when the upper bridge arm of the corresponding phase of the first inverter is turned on, the battery, the upper bridge arm of the corresponding phase of the first inverter, the winding of the corresponding phase of the open winding motor, the upper bridge arm of the corresponding phase of the second inverter, and a second load apparatus connected in parallel to the distal side of the second inverter form a standard discharging loop; and
when the lower bridge arm of the corresponding phase of the first inverter is turned on, the winding of the corresponding phase of the open winding motor, the upper bridge arm of the corresponding phase of the second inverter, the second load apparatus, and the lower bridge arm of the corresponding phase of the first inverter form a buck discharging loop.

8. The electric drive system according to claim 1, further comprising:
a capacitor connected in parallel to the distal side of the second inverter; and
a second switch connected between the capacitor and the second inverter, wherein
the control apparatus is configured to control the second switch to be turned on in the charging mode and the discharging mode of the electric drive system.

9. The electric drive system according to claim 8, wherein the electric drive system is further configured with a single-inverter drive mode; and
the control apparatus is configured to control both the first switch and the second switch to be turned off, the second inverter to operate in an active short circuit mode, and the first inverter to drive the open winding motor alone in the single-inverter drive mode.

10. The electric drive system according to claim 8, wherein the electric drive system is further configured with a dual-inverter drive mode; and
the control apparatus is configured to control the first switch to be turned on, the second switch to be turned on or turned off, and the pair of inverters to jointly drive the open winding motor in the dual-inverter drive mode.

11. The electric drive system according to claim 8, wherein the second switch is arranged at an end of the second inverter; or
the second switch is arranged at an end of the capacitor.

12. The electric drive system according to claim 8, wherein at least one of the second switch and/or the first switch is a power semiconductor switch.

13. A control method used to control an electric drive system, comprising:
controlling a first switch to be turned off, an upper bridge arm of a second inverter to be turned on, and a lower bridge arm of the second inverter to be turned off, and a lower bridge arm and an upper bridge arm of a corresponding phase of a first inverter to be alternately turned on through synchronous or asynchronous first PWM signals of each phase in response to connecting a first direct current power supply apparatus whose output voltage is lower than a voltage of a battery to a distal side of the second inverter, such that the electric drive system enters a boost charging mode in which the first direct current power supply apparatus first charges a winding of the corresponding phase of an open winding motor, and then charges the battery through the winding of the corresponding phase of the open winding motor.

14. The control method according to claim 13, further comprising:
controlling the first switch to be turned off, the upper bridge arm of the first inverter to be turned on and the lower bridge arm of the first inverter to be turned off, and the lower bridge arm and the upper bridge arm of the corresponding phase of the second inverter to be alternately turned on through synchronous or asynchronous second PWM signals of each phase in response to connecting a first load apparatus whose load voltage is higher than the voltage of the battery to the distal side of the second inverter, such that the electric drive system enters a boost discharging mode in which the battery first discharges to the winding of the corresponding phase of the open winding motor and then discharges to the first load apparatus through the winding of the corresponding phase of the open winding motor.

15. The control method according to claim 13, further comprising:
controlling the first switch to be turned off, the upper bridge arm of the second inverter to be turned on and the lower bridge arm of the second inverter to be turned off, and the upper bridge arm and the lower bridge arm of the corresponding phase of the first inverter to be alternately turned on through synchronous or asynchronous third PWM signals of each phase in response to connecting a second load apparatus whose load voltage is lower than the voltage of the battery to the distal side of the second inverter, such that the electric drive system enters a buck discharging mode in which the battery first discharges to the second load apparatus through the winding of the corresponding phase of the open winding motor and then the winding of the corresponding phase of the open winding motor discharges to the second load apparatus.

16. The control method according to claim 13, wherein the electric drive system further comprises a capacitor connected in parallel to the distal side of the second inverter and a second switch connected between the capacitor and the second inverter, wherein the second switch is controlled to be turned on in the charging mode and the discharging mode of the electric drive system;
wherein the control method further comprises:
in response to a single-inverter drive signal, controlling both the first switch and the second switch to be turned off, the second inverter to operate in an active short circuit mode, and the first inverter to operate in a single-inverter drive mode in which the first inverter drives the open winding motor alone through a first SVPWM signal; and
in response to a dual-inverter drive signal, controlling the first switch to be turned on, the second switch to be turned on or turned off, and the two inverters to operate in a dual-inverter drive mode in which the two inverters jointly drive the open winding motor through second SVPWM signals.

17. The control method according to claim 13, further comprising:
synchronously controlling, according to power requirements, bridge arms of one phase, two phases, or three phases of the inverters operating in working modes,
wherein the working modes comprise the charging mode, a discharging mode, and a drive mode.

18. An electronic device, comprising:
a processor; and
a memory storing executable instructions,
wherein, when the executable instructions are executed by the processor, the control method according to claim 13 is implemented.

19. A non-transitory computer-readable storage medium storing a program, wherein when the program is executed by a processor, the processor performs the control method according to 13.

20. A control apparatus, comprising:
a boost charging controller configured to:
control a first switch to be turned off, an upper bridge arm of a second inverter to be turned on, and a lower bridge arm of the second inverter to be turned off, and a lower bridge arm and an upper bridge arm of a corresponding phase of a first inverter to be alternately turned on through synchronous or asynchronous first PWM signals of each phase in response to connecting a first direct current power supply apparatus whose output voltage is lower than a voltage of a battery to a distal side of the second inverter, such that the electric drive system enters a boost charging mode in which the first direct current power supply apparatus first charges the winding of the corresponding phase of an open winding motor, and then charges the battery through the winding of the corresponding phase of the open winding motor.
